(19) United States
(12) Patent Application Publication
(10) Pub. No.: US 2012/0159515 A1
(43) Pub. Date: Jun. 21, 2012

(54) SHARING OBJECT REPRESENTATIONS

(75) Inventors: Marcos Calderon, Seattle, WA (US); Ashish Gupta, Bellevue, WA (US); Peter Villadsen, Sammamish, WA (US)

(73) Assignee: Microsoft Corporation, Redmond, WA (US)

(21) Appl. No.: 12/969,590

(22) Filed: Dec. 16, 2010

(51) Int. Cl. G06F 9/44

(52) U.S. Cl. 719/316

(57) ABSTRACT

Concepts and technologies are described herein for sharing object representations between one or more runtime environments. In accordance with the concepts and technologies disclosed herein, logic defining objects includes references to one or more object proxies. Logic defining the object proxies can include a reference to at least one object corresponding to the object proxy. When an object reference associated with the object proxy is generated, the object reference is routed to the object corresponding to the object proxy. According to various implementations, the object is accessed via accessing the object proxy. Thus, the object may appear native to the runtime environment in which the object proxy resides. In some embodiments, a conduit translates object references from object proxies to objects, and enables communications between runtime environments. Objects also can be referenced by more than one object proxies.

### BACKGROUND

In object-oriented programming, a class is a construct that is used as a blueprint (or template) to create instances of the class, referred to as objects. The class describes the state and behavior that objects of the class share. The class describes the state of the objects with attributes, also referred to as member variables or instance variables. The class describes the behavior of the objects with reusable code called methods.

Thus, a class may be described as a package of metadata describing states and behaviors. Classes have an interface that describes how the class and objects are interacted with via methods, and structure that defines how data in the objects is partitioned into attributes. A class also can have a representation, called a metaobject at run time that provides support for manipulating the class-related metadata.

Objects can be grouped together in a runtime environment and can be isolated from access by other software or runtime environments. While the objects can be isolated from access by other software, access to the objects can be allowed, in some instances. For example, other software can be allowed to access the objects via calls to procedures or functions of the object that have been configured to allow calling by the other software. Thus, the objects may be capable of processing data and supporting method calls from other objects, but may not be shared with other runtime environments. Because of the independence of the objects, management of the object and tracking of object usage is simplified.

In the object-oriented model of programming, however, sharing and recycling of code between runtime environments may be difficult. In particular, because the data corresponding to the objects may be specific to a particular runtime environment, sharing the objects between runtime environments may be difficult or impossible. Thus, the object-oriented model of programming provides benefits with respect to management and tracking, but may pose challenges with regard to recycling and sharing object instances between software and/or runtime environments.

It is with respect to these and other considerations that the disclosure made herein is presented.

### SUMMARY

Concepts and technologies are described herein for sharing object representations. In accordance with the concepts and technologies disclosed herein, objects associated with one runtime environment exist or are created. An object proxy that references the object also is created. Logic defining the object proxy can identify an object associated with the object proxy, a runtime environment in which the object resides, and information for accessing the object. Similarly, logic defining objects can identify one or more object proxies associated with the object. Thus, when an object proxy is referenced in a runtime environment, the object reference can be routed to the object identified by the logic defining the object proxy. From the perspective of a particular runtime environment, the object proxy is native to the runtime environment, though the object corresponding to the object proxy may actually reside in a different runtime environment.

According to one aspect, a conduit manages sharing of object representations between two or more runtime environments. If a runtime environment references an object proxy, the conduit routes the object reference to the object in another runtime environment and provides the object implementation based upon the object reference as if the object was directly referenced by the runtime environment. In some implementations, the conduit stores or accesses translation data that defines relationships between the objects and object proxies and/or how communications between the runtime environments is enabled. The translation data used to identify the objects and/or object proxies can be generated based upon logic defining the objects and/or object proxies.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary operating environment for the various embodiments disclosed herein.

FIG. 2 is a flow diagram showing aspects of a method for sharing object representations, according to an exemplary embodiment.

FIG. 3 is a flow diagram showing aspects of another method for sharing object representations, according to an exemplary embodiment.

FIG. 4 is a computer architecture diagram illustrating an exemplary computer hardware and software architecture for a computing system capable of implementing aspects of the embodiments presented herein.

### DETAILED DESCRIPTION

The following detailed description is directed to concepts and technologies for sharing object representations. According to the concepts and technologies described herein, objects and/or object proxies associated with one or more runtime environments exist or are created. Logic defining the object proxies can identify objects associated with the object proxies, runtime environments in which the objects reside, and information for accessing the objects. Similarly, logic defining the objects can identify one or more object proxies associated with the objects, runtime environments in which the object proxies reside, and information for accessing the object proxies.

If an object proxy is referenced in a runtime environment, the object reference can be routed to the object identified by the logic defining the object proxy. From the perspective of runtime environments, object proxies are objects that are native to the runtime environments, though the objects corresponding to the object proxies may reside in different runtime environments. Thus, the object proxies can be used to allow runtime environments to call methods on and pass parameters to objects associated with other runtime environments at runtime.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for sharing object representations will be presented.

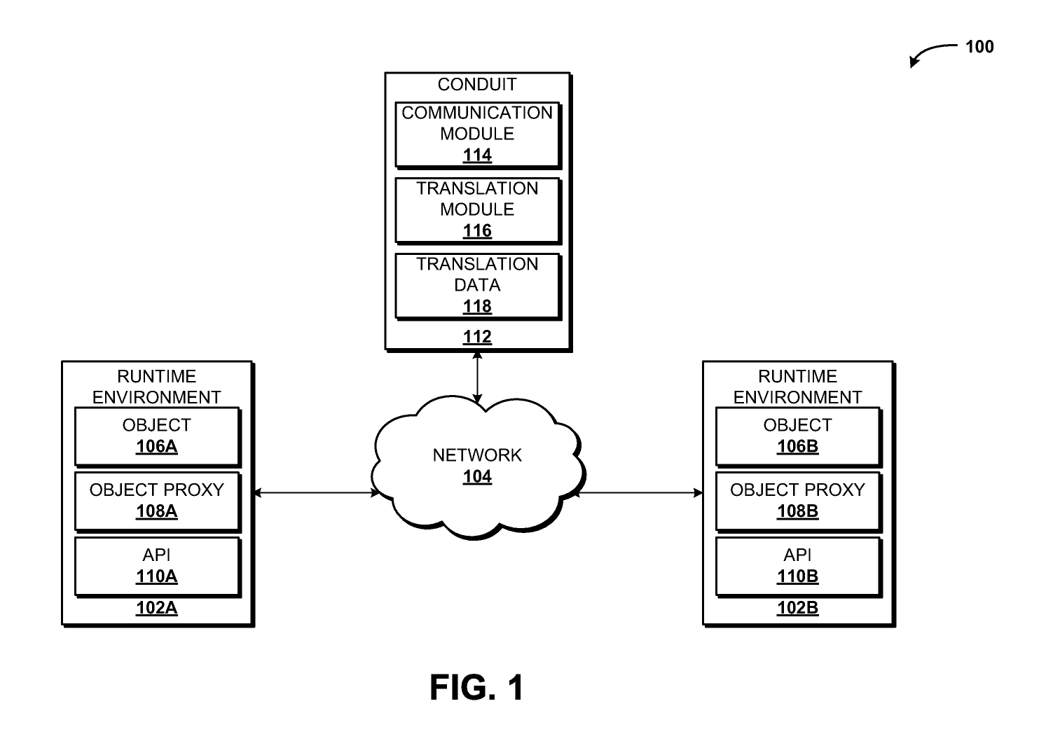

Referring now to FIG. 1, aspects of one operating environment 100 for the various embodiments presented herein will be described. The operating environment 100 includes two runtime environments 102A, 102B, hereinafter collectively referred to as runtime environments 102. The runtime environments 102 include hardware and software for executing object-oriented programs and include, but are not limited to, operating systems, application programs, virtual machines, and the like. In one embodiment, one of the runtime environments 102 includes an operating system, and another of the runtime environments 102 includes an application program. In another embodiment, one of the runtime environments includes a first application program such as a member of the MICROSOFT DYNAMICS family of products from MICROSOFT CORPORATION in Redmond, Wash., and another of the runtime environments includes a managed code environment such as a .NET environment. It should be understood that these embodiments are exemplary, and should not be construed as being limiting in any way.

According to various embodiments, the runtime environments 102 are configured to communicate with or via a communications network 104 (“network”). According to various embodiments, the runtime environments 102 are configured as object-oriented environments. Thus, although not illustrated in FIG. 1, it should be understood that the runtime environments 102 can include infrastructure for managing objects 106A, 106B, hereinafter collectively referred to as objects 106. The infrastructure for managing the objects 106 can be used to manage the objects 106 during any part of the object lifetime, from creation to reclamation. The objects 106 are substantially similar to objects traditionally used or represented in object-oriented programming environments. Thus, for the sake of brevity, the objects 106 will not be further described herein.

The runtime environments 102 also can include infrastructure for managing object proxies 108A, 108B, hereinafter collectively referred to as object proxies 108. The object proxies 108 are created in a runtime environment 102 and are accessed in the runtime environment 102 in a manner similar to the manner in which native objects such as the objects 106 are accessed in the runtime environments 102. The object proxies 108, however, actually reference objects 106 in other runtime environments 102. Thus, when an object proxy 108 is accessed in a runtime environment 102, the reference or access to the object proxy 108 is translated to an object 106 in another runtime environment 104.

According to various embodiments, the object proxies 108 are tied to the objects 106 via code. Thus, objects 106 in one runtime environment 102 are shared with another runtime environment 102 without actually reproducing the object 106. The object proxies 108 do not necessarily contain any states of their own. The states of the object 106 associated with the object proxies 108 are relied upon when the object proxies 108 are called. More particularly, when methods are called on the object proxies 108, the method calls can be routed to the corresponding objects 106 in the other runtime environment 102.

The object proxies 108 can be created or coded by programmers or developers, and/or via other means. In some embodiments, the object proxies 108 are created or coded in a manner substantially similar to the manner in which the objects 106 are created or coded. In other embodiments, the object proxies 108 are generated via one or more user or device interfaces configured for generating code for the object proxies 108 based upon user or device input. According to various embodiments, code corresponding to the object proxies 108 includes references to objects 106 in other runtime environments 102 and/or logic indicating how access of or references to the object proxies 108 are translated to enable access of or reference to the corresponding objects 106. Thus, the logic associated with a particular object proxy 108 can indicate how an object 106 in a first runtime environment 102 can be accessed via access of an object proxy 108 in a second runtime environment. In the illustrated embodiment, for example, logic corresponding to the object proxy 108A represented in the runtime environment 102A can include one or more references to the object 106B represented in the runtime environment 102B. Similarly, logic corresponding to the object proxy 108B in the runtime environment 102B can include one or more references to the object 106A represented in the runtime environment 102A. While not necessarily illustrated in FIG. 1, the runtime environments 102 can include infrastructure such as hardware and/or software for creating, managing, using, and disposing of the objects 106 and object proxies 108.

The runtime environments 102 also can include application programming interfaces (“APIs”) 110A, 110B, hereinafter collectively referred to as APIs 110. The APIs 110 include one or more interfaces for allowing communications between the runtime environments 102 and networks, environments, devices, systems, and/or other entities. In some embodiments, communications between the runtime environment 102A and the runtime environment 102B occur via respective APIs 110 and the network 104. This embodiment is exemplary and should not be construed as being limiting in any way.

In some embodiments, the operating environment 100 also includes a conduit 112 operating on or in communication with the network 104. According to various embodiments, the functionality of the conduit 112 is provided by one or more personal computers (“PCs”), server computers, and/or hardware configured to execute one or more applications. In the illustrated embodiment, the functionality of the conduit 112 is provided by a server computer configured to execute an operating system (not illustrated) and one or more application programs. It should be understood that this embodiment is exemplary, and should not be construed as being limiting in any way.

While the operating environment 100 illustrated in FIG. 1 shows the runtime environments 102 and the conduit 112 embodied separately, it should be understood that one or more or all of the runtime environments 102 and the conduit 112 can reside and/or be executed by a single device or combination of devices. For example, in one embodiment the runtime environment 102A is an operating system of a computer, and the runtime environment 102B includes an environment such as software and/or hardware for providing a virtual machine implementation of .NET, JAVA, CGI, or other code or scripts. The functionality of the conduit 112, meanwhile, can be provided by a software application executing on the same device, if desired. Thus, it should be understood that the illustrated embodiment is exemplary and should not be construed as being limiting in any way.

The operating system is a computer program for controlling the operation of the conduit 112 and the application programs are executed on top of the operating system to provide the functionality described herein for sharing object representations. The application programs include, but are not necessarily limited to, a communication module 114 and a translation module 116. Although the communication module 114 and the translation module 116 are illustrated as components of the conduit 112, it should be understood that each of these modules, or combinations thereof, may be embodied as or in stand-alone devices or components thereof operating on or in communication with the network 104 and/or the conduit 112. Thus, the illustrated embodiment is exemplary, and should not be construed as being limiting in any way.

The communication module 114 is executed by the conduit 112 to enable communications between the runtime environments 102 and one or more networks, devices, applications, and the like, as is described in more detail herein. More particularly, the communication module 114 is executable by the conduit 112 to cause the conduit 112 to determine and/or enable communications between the runtime environments 102 based upon access of an object 106 and/or object proxy 108. The communication module 114 is configured to recognize which APIs 110 are available and/or may be used to allow access of the objects 106 or object proxies 108 in the runtime environments 102. Thus, when an object proxy 108 is accessed in one of the runtime environments 102, the communication module 114 is configured to describe how an object 106 corresponding to the accessed object proxy 108 may be accessed. Furthermore, the communication module 114 can enable communications between the runtime environments 102 via the APIs 110 and/or via other means.

The translation module 116 is executed by the conduit 112 to map an object reference in one runtime environment 102 to another runtime environment 102. More particularly, when an object proxy 108 is accessed or referenced in one runtime environment 102, the conduit 112 is configured to execute the translation module 116 to identify a corresponding object 106 in another runtime environment 102. It will be appreciated that the translation module 116 can base this identification can be based upon logic corresponding to the object proxy 108, as explained herein. Additionally, or alternatively, the translation module 116 is executed by the conduit 112 to identify object proxies 108 that correspond to updated, accessed, created, or reclaimed objects 106 to allow deletion of unneeded object proxies 108. According to various embodiments, the conduit 112 stores or accesses translation data 118. The translation data 118 can be used or queried by the conduit 112 to identify objects 106 or object proxies 108 that correspond to objects 106 or object proxies 108 that have been accessed, referenced, updated, created, or reclaimed.

It will be appreciated that the conduit 112 is thus configured, via execution of the communication module 114 and the translation module 116, to recognize an access of or reference associated with an object 106 or object proxy 108 in one runtime environment 102, to identify a corresponding object 106 or object proxy 108 in a second runtime environment 102, and to enable communications between the runtime environments 102. While the translation data 118 is illustrated as a component of the conduit 112, it should be understood that the translation data 116 can be stored in a stand-alone device such as one or more databases, server computers, desktop computers, mobile telephones, laptop computers, memory devices, and/or other data storage or computing devices, if desired.

FIG. 1 illustrates two runtime environments 102, one network 104, and one conduit 112. It should be understood, however, that some implementations of the operating environment 100 include more than two runtime environments 102, multiple networks 104, and multiple conduits 112. Thus, the illustrated embodiments should be understood as being exemplary, and should not be construed as being limiting in any way.

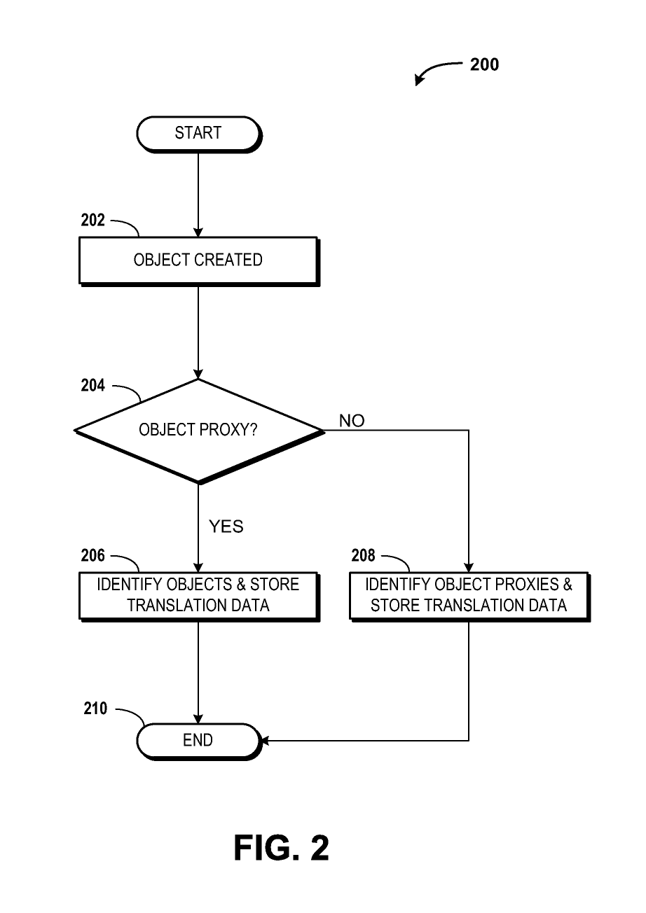

Turning now to FIG. 2, aspects of a method 200 for sharing object representations will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in their respective entireties. Some or all operations of the methods disclosed herein, and/or substantially equivalent operations, can be performed by execution of computer-readable instructions included on a computer-storage media, as defined above. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts of the present disclosure, the methods disclosed herein are described as being performed by the conduit 112. It should be understood that these embodiments are exemplary, and should not be viewed as being limiting in any way. The method 200 begins at operation 202, wherein an object 106 or an object proxy 108 is created in one of the runtime environments 102. According to some embodiments, an object 106 is created in one of the runtime environments 102. As mentioned above, creation of the objects 106 can be accomplished in a manner substantially similar to a manner in which objects are created in object-oriented environments. As such, creation of the objects 106 is not described in additional detail herein. It should be understood, however, that the objects 106 can include logic for identifying one or more object proxies 108 associated with the objects 106, if desired.

According to other embodiments, the operation 202 includes creation of an object proxy 108 in one of the runtime environments 102. The object proxies 108 can be created in a manner substantially similar to the manner in which the objects 106 are created, if desired. In some embodiments, a user, device, or other entity creates the object proxy 108 in a runtime environment 102 via hard coding. In other embodiments, the user, device, or other entity creates the object proxy 108 via a user interface or other means that automatically generates the object proxy 108 with appropriate references to objects 106. The object proxy 108, as mentioned above, includes references to an object 106 in another runtime environment 102, one or more references to the object 106 in the other runtime environment 102, information indicating how to access the object 106 in the other runtime environment 102, and/or other information. None, some, or all of the information can be stored as the translation data 118 described above.

From operation 202, the method 200 proceeds to operation 204, wherein the conduit 112 determines if the object created in operation 202 is an object 106 or an object proxy 108. If the conduit 112 determines in operation 204 that the object created in operation 202 is an object proxy 108, the method 200 proceeds to operation 206. In operation 206, the conduit 112 identifies objects 106 corresponding to the object proxies 108 and generates the translation data 118 described above for identifying an object 106 corresponding to the created object proxy 108. As mentioned above, the logic corresponding to the object proxy 108 can include the information for identifying the object 106 to enable the references of the object proxy 108 to be translated to references of the object 106 at runtime.

Thus, the conduit 112 can be configured to extract this information and store the information as the translation data 118. In other embodiments, the operation 206 includes the conduit 112 generating information for mapping object references associated with the object proxy 108 to the corresponding object 106, as well as information for enabling communications between the runtime environments 102. The conduit 112 can store the translation data 118 at the conduit 112 and/or at a data storage location accessible by the conduit 112.

If the conduit 112 determines in operation 204 that the object created in operation 202 is an object 106, the method 200 proceeds to operation 208, wherein the conduit 112 identifies any object proxies 108 that reference the object 106, if any. Any such references can be identified and stored as the translation data 118 by the conduit 112, if desired. Thus, as explained above, any changes to the object 106 can be propagated to corresponding object proxies 108 to ensure that the object proxies are accurate representations of the object 106. From operations 206 and 208, the method 200 proceeds to operation 210. The method 200 ends at operation 210.

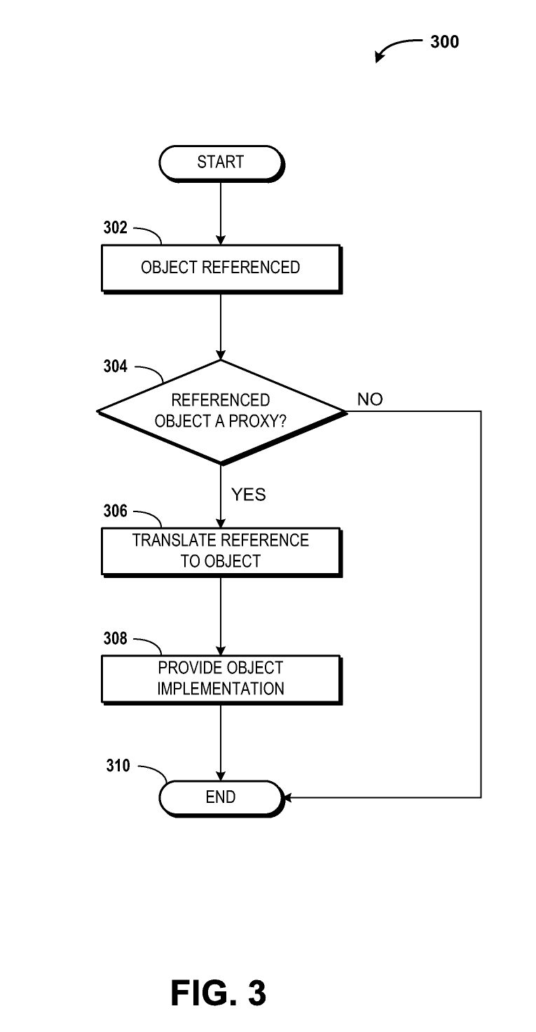

Turning now to FIG. 3, aspects of another method 300 for sharing object representations will be described in detail. The method 300 begins at operation 302, wherein the conduit 112 detects an object reference. According to various embodiments, the object reference detected by the conduit 112 can correspond to a reference associated with an object 106 or an object proxy 108. Furthermore, the reference detected by the conduit 112 can include a method call, passage of a parameter, creation of an object 106, reclamation of an object 106 or object proxy 108, or the like. As explained above, the object proxies 108 can be coded to invoke communications via the conduit 112 when called or referenced. Thus, the conduit 112 can become aware of the object reference via monitoring of the objects 106 and/or the object proxies 108, via communications detected by the conduit 112, or the like.

From operation 302, the method 300 proceeds to operation 304, wherein the conduit 112 determines if the referenced object is an object 106 or an object proxy 108. As mentioned above, the conduit 112 can determine what type of reference is detected in operation 302 based upon monitoring information, detecting communications, and/or via other means. The conduit 112 also can access or query the translation data 118, if desired, to determine if the referenced object is an object 106 or an object proxy 108.

If the conduit 112 determines in operation 304 that the referenced object is an object proxy 108, the method 300 proceeds to operation 306, wherein the conduit 112 translates the object reference to an object 106 corresponding to the object proxy 108. As mentioned above, in some embodiments the conduit 112 can identify the corresponding object 106 via accessing or querying the translation data 118, if desired. Additionally, or alternatively, the conduit 112 can examine the logic corresponding to the object proxy 108 to identify a corresponding object 106.

The conduit 112, via execution of the translation module 116, translates or maps the object proxy 108 to the object 106 based upon the object proxy logic 108 and/or the translation data 116. According to various implementations, the conduit 112 executes the communication module 114 to determine how communications between the runtime environments 102 can be completed, and to enable the communications between the runtime environments 102 based upon the determined information. In some embodiments, for example, the conduit 112 determines any APIs 110 or other interfaces or networks that may be used to communicate between the runtime environments 102. Thus, the conduit 112 can map object references associated with an object proxy 108 in one runtime environment 102 to an object 106 in another runtime environment 102 and determine how communications between the runtime environments 102 can be completed.

From operation 306, the method 300 proceeds to operation 308, wherein the conduit 112 provides the object implementation by enabling communications between the two runtime environments 102. Thus, the conduit 112 enables access of an object 106 via accessing an object proxy 108. It should be appreciated that according to various implementations of the concepts and technologies disclosed herein, an object proxy 108 accessed in one runtime environment 102 can be accessed by the runtime environment 102 as if the object proxy 108 was an object native to the runtime environment 102. Furthermore, it should be understood that the runtime environment 102 is able to seamlessly access the object 106 via the object proxy 108, the APIs 110, and the conduit 112 as if the object 106 resided in the runtime environment 102 in which the object proxy 108 resides.

From operation 308, and from operation 304 if the conduit 112 determines that the referenced object is not a proxy, the method 300 proceeds to operation 310. The method 300 ends at operation 310. While the method 300 has been described with respect to reference of an object proxy 108, it should be understood that the method 300 can also be used with regard to references of objects 106. Thus, the method 300 can be executed by the conduit 112 to implement objects 106 and/or object proxies 108. Although not illustrated in FIG. 3, it should be understood that if the conduit 112 determines in operation 304 that an object 106 has been referenced, implementation of the object 106 can proceed in a substantially normal manner within the runtime environment 102 in which the object 106 resides.

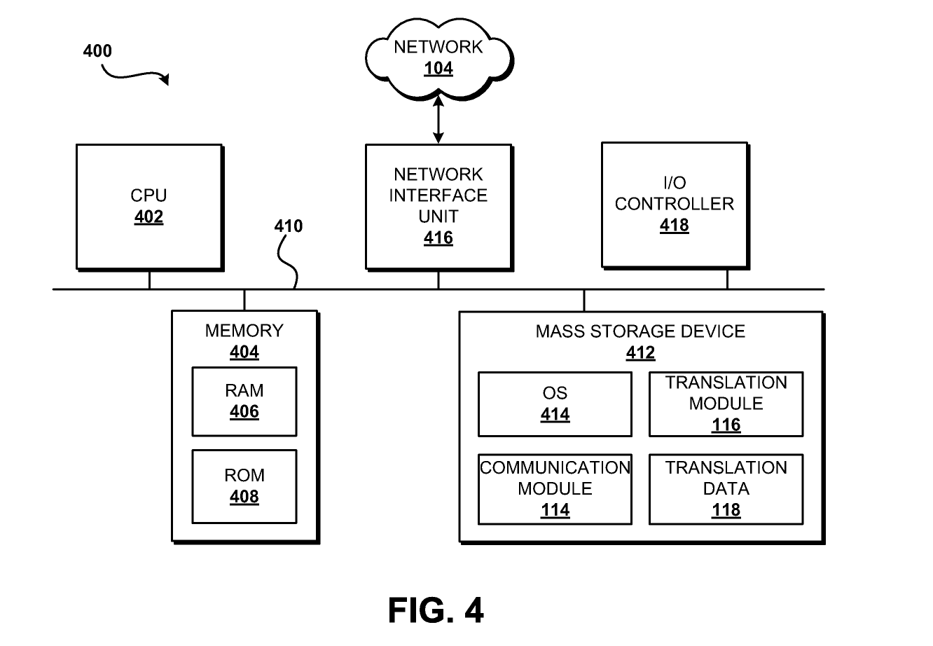

FIG. 4 illustrates an exemplary computer architecture 400 for a device capable of executing the software components described herein for sharing object representations. Thus, the computer architecture 400 illustrated in FIG. 4 illustrates an architecture for a server computer, mobile phone, a PDA, a smart phone, a server computer, a desktop computer, a netbook computer, a tablet computer, and/or a laptop computer. The computer architecture 400 may be utilized to execute any aspects of the software components presented herein.

The computer architecture 400 illustrated in FIG. 4 includes a central processing unit 402 (“CPU”), a system memory 404, including a random access memory 406 (“RAM”) and a read-only memory (“ROM”) 408, and a system bus 410 that couples the memory 404 to the CPU 402. A basic input/output system containing the basic routines that help to transfer information between elements within the computer architecture 400, such as during startup, is stored in the ROM 408. The computer architecture 400 further includes a mass storage device 412 for storing the operating system 414, the communication module 108, the translation module 110, and the translation data 112.

The mass storage device 412 is connected to the CPU 402 through a mass storage controller (not shown) connected to the bus 410. The mass storage device 412 and its associated computer-readable media provide non-volatile storage for the computer architecture 400. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 400.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 400. For purposes the claims, the phrase “computer storage medium” and variations thereof, does not include waves, signals, and/or other transitory and/or intangible communication media, per se.

According to various embodiments, the computer architecture 400 may operate in a networked environment using logical connections to remote computers through a network such as the network 104. The computer architecture 400 may connect to the network 104 through a network interface unit 416 connected to the bus 410. It should be appreciated that the network interface unit 416 also may be utilized to connect to other types of networks and remote computer systems, for example, the client device 118. The computer architecture 400 also may include an input/output controller 418 for receiving and processing input from a number of other devices, including a keyboard, mouse, or electronic stylus (not shown in FIG. 4). Similarly, the input/output controller 418 may provide output to a display screen, a printer, or other type of output device (also not shown in FIG. 4).

It should be appreciated that the software components described herein may, when loaded into the CPU 402 and executed, transform the CPU 402 and the overall computer architecture 400 from a general-purpose computing system into a special-purpose computing system customized to facilitate the functionality presented herein. The CPU 402 may be constructed from any number of transistors or other discrete circuit elements, which may individually or collectively assume any number of states. More specifically, the CPU 402 may operate as a finite-state machine, in response to executable instructions contained within the software modules disclosed herein. These computer-executable instructions may transform the CPU 402 by specifying how the CPU 402 transitions between states, thereby transforming the transistors or other discrete hardware elements constituting the CPU 402.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 400 in order to store and execute the software components presented herein. It also should be appreciated that the computer architecture 400 may include other types of computing devices, including hand-held computers, embedded computer systems, personal digital assistants, and other types of computing devices known to those skilled in the art. It is also contemplated that the computer architecture 400 may not include all of the components shown in FIG. 4, may include other components that are not explicitly shown in FIG. 4, or may utilize an architecture completely different than that shown in FIG. 4.

Based on the foregoing, it should be appreciated that technologies for sharing object representations have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for sharing object representations, the computer-implemented method comprising performing computer-implemented operations for:
detecting, at a conduit, an object reference associated with a first runtime environment;
determining if the object reference is associated with an object or an object proxy;
in response to determining that the object reference is associated with the object proxy, identifying an object associated with the object proxy; and
translating the object reference to the object associated with the object proxy.

2. The method of claim 1, wherein identifying the object associated with the object proxy comprises accessing translation data to obtain information identifying the object.

3. The method of claim 1, wherein methods called on the object proxy are routed to the object associated with the object proxy, the object being associated with a second runtime environment.

4. The method of claim 3, further comprising providing the object implementation.

5. The method of claim 1, wherein logic defining the object proxy comprises data identifying the object corresponding to the object proxy.

6. The method of claim 1, wherein translating the object reference to the object comprises routing the object reference from the object proxy to the object.

7. The method of claim 2, wherein the translation data comprises information associating the object with the object proxy.

8. The method of claim 7, object reference comprises a method call, and wherein providing the object implementation comprises routing the method call from the object proxy to the object, the object being associated with a second runtime environment.

9. The method of claim 1, further comprising in response to determining that the object reference is associated with the object, implementing the object reference.

10. The method of claim 9, wherein logic defining the object comprises data identifying one or more object proxies associated with the object.

11. The method of claim 10, further comprising:
in response to detecting an update of the object, accessing translation data to identify the object proxies; and
update the object proxies to reflect the update of the object.

12. A computer-implemented method for sharing object representations, the computer-implemented method comprising performing computer-implemented operations for:
detecting, at a conduit, an object reference associated with a first runtime environment in communication with a second runtime environment;
determining if the object reference is associated with an object in the first runtime environment or an object proxy associated with an object in the second runtime environment;
in response to determining that the object reference is associated with the object proxy, identifying the object associated with the object proxy;
translating the object reference to the object associated with the object proxy; and
providing an implementation of the object.

13. The method of claim 12, wherein the object reference comprises a method call, and wherein providing the object implementation comprises routing the method call from the object proxy to the object in the second runtime environment.

14. The method of claim 12, wherein the object reference comprises passage of a parameter to the object proxy, and wherein providing the object implementation comprises routing the parameter from the object proxy to the object in the second runtime environment.

15. The method of claim 12, wherein logic defining the object proxy comprises data identifying the object corresponding to the object proxy and data identifying the second runtime environment.

16. The method of claim 12, further comprising:
generating translation data comprising information associating objects with object proxies; and
storing the translation data in a data storage location accessible by the conduit.

17. The method of claim 16, wherein translating the object reference to the object associated with the object proxy comprises analyzing the translation data to identify the object associated with the object proxy.

18. The method of claim 17, wherein the object reference is routed to the second runtime environment via at least one application programming interface.

19. A computer storage medium having computer readable instructions stored thereupon that, when executed by a computer, cause the computer to:
generate, at a conduit, translation data identifying an association between an object proxy in a first runtime environment and an object in a second runtime environments;
detect, at the conduit, a method call generated in the first runtime environment;
determine if the method call is associated with an object in the first runtime environment or the object proxy, the object proxy being associated with an object in the second runtime environment;
in response to determining that the method call is associated with the object proxy, identify the object associated with the object proxy;
translate the method call to the object associated with the object proxy;
determine a communication path between the first runtime environment and the second runtime environment, the communication path comprising one or more application programming interfaces; and
route the method call from the object proxy to the object in the second runtime environment.

20. The computer storage medium of claim 19, wherein logic defining the object proxy comprises data identifying the object corresponding to the object proxy, the second runtime environment, and the communication path between the first runtime environment and the second runtime environment, and
wherein logic defining the object comprises data identifying one or more object proxies associated with the object.
